(19) United States
(12) Patent Application Publication
(10) Pub. No.: US 2008/0022117 A1
(43) Pub. Date: Jan. 24, 2008

(54) Enabling access to more than one encrypted data segment of a segmentable data stream

(76) Inventor: Antonius Kalker, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/492,230

(22) Filed: Jul. 21, 2006

(51) Int. Cl. H04L 9/00

(52) U.S. Cl. 713/182

(57) ABSTRACT

A system and method for enabling access to more than one encrypted data segment of a segmentable data stream wherein the data stream includes a plurality of the encrypted data segments is disclosed. A relationship between at least two encrypted data segments to be accessed is determined. A key is provided to the related encrypted data segments to be accessed such that the provided key can be used to access the related encrypted data segments. The key is utilized to access the related encrypted data segments but the key is not required to provide access to the entire segmentable data stream.

### TECHNICAL FIELD

Embodiments of the present invention relate to a method and a system for enabling secure access to a portion of a segmentable data stream.

### BACKGROUND

Information can be represented digitally and presented to end-users through various means such as image, video, sound, text, speech or computer programs to name a few. One method to present digital information to end-users is by implementing a multimedia application. Multimedia generally refers to the presentation of text, graphic, video, animation, and sound in an integrated way. The use of multimedia is ubiquitous in present computing environments.

Multimedia has often been presented in a packetized format known as packetized multimedia (P-MM). P-MM multimedia consists of a series of discrete packets, which are presented in a data stream to be sent and received by end-users. For various reasons, a need has risen to provide efficient and secure access to P-MM. For example, a multimedia provider (e.g., music content provider) may wish to grant paying end-users access to the music content. One way to grant access to multimedia data involves encrypting the P-MM and providing a key for decrypting the P-MM to authorized end-users. A key can be provided to the entire segmentable data stream of P-MM, which provides access to the entire data stream. In the case of P-MM, however, it is often not desired to encrypt the entire data stream with a single key. Specifically, if a single key is used to encrypt the entire data stream, any user who is provided the single key will necessarily have access to the entire data stream. Hence, users are either granted access to all or none of the data stream depending on whether or not they are given the appropriate single key.

In some instances, it is desirable to grant limited access to a user. That is, a user is granted access to only a portion of the encrypted data stream. As such, there is a need to provide an efficient and secure selective access to P-MM. For example, a multimedia provider may wish to provide access to only a small portion of an encrypted data stream (e.g., middle third of a video clip) such that a user may form an opinion on whether to obtain full access. One possible way to provide access to only a portion of multimedia data stream is to encrypt each data segment with a corresponding key and provide only the corresponding key for the selected encrypted segment of the data stream to the end-user.

However, this method is time consuming and is not cost effective. Furthermore, if the end user does choose to obtain additional access or even full access, the end-user must then handle many keys. A slightly more efficient option is a key scheme where the data is linearly arranged and where a specific key gives access to all data from a certain point on. Although this is better than the all or nothing scheme, it limits the number of subsets that can be decrypted to lower bounded intervals in the data stream.

### DISCLOSURE OF THE INVENTION

A system and method for enabling access to more than one encrypted data segment of a segmentable data stream wherein the data stream includes a plurality of the encrypted data segments is disclosed. A relationship between at least two encrypted data segments to be accessed is determined. A key is provided to the related encrypted data segments to be accessed such that the provided key can be used to access the related encrypted data segments. The key is utilized to access the related encrypted data segments but the key is not required to provide access to the entire segmentable data stream.

### BRIEF DESCRIPTION OF THE DRAWINGS

The accompanying drawings, which are incorporated in and form a part of this specification, illustrate embodiments of the present invention and, together with the description, serve to explain the principles of the invention. Unless specifically noted, the drawings referred to in this description should be understood as not being drawn to scale.

FIG. 1 shows an exemplary general purpose computer system that may be utilized in accordance with one embodiment of the present invention.

FIG. 2 shows an exemplary multimedia data structure with segmentable data stream with corresponding encryption keys in accordance with one embodiment of the present invention.

FIG. 3 shows an exemplary system for providing a method for enabling access to more than one encrypted data segment of a segmentable data stream data in accordance with one embodiment of the present invention.

FIG. 4 shows an exemplary key utilizer in accordance with one embodiment of the present invention.

FIG. 5 is a flowchart of a computer implemented process for providing a method for enabling access to more than one encrypted data segment of a segmentable data stream data in accordance with one embodiment of the present invention.

FIG. 6 is a flowchart of a process implemented by a key utilizer in accordance with one embodiment of the present invention.

FIG. 7 shows an exemplary tree structure representing of a key hierarchy in accordance with one embodiment of the present invention.

FIG. 8 shows an exemplary tree structure representing of a key hierarchy in accordance with another embodiment of the present invention.

FIG. 9 shows an exemplary tree structure representing of a key hierarchy in accordance with another embodiment of the present invention.

### DETAILED DESCRIPTION

Reference will now be made in detail to embodiments for enabling access to more than one encrypted data segment of a segmentable data stream, examples of which are illustrated in the accompanying drawings. While the technology for enabling access to more than one encrypted data segment of a segmentable data stream will be described in conjunction with these embodiments, it will be understood that they are not intended to limit the present technology. On the contrary, the technology for enabling access to more than one encrypted data segment of a segmentable data stream is intended to cover alternatives, modifications and equivalents, which may be included within the spirit and scope of the invention as defined by the appended claims. Furthermore, in the following detailed description, numerous specific details are set forth in order to provide a thorough understanding of the technology for enabling access to more than one encrypted data segment of a segmentable data stream. However, it will be evident to one of ordinary skill in the art that the invention may be practiced without these specific details. In other instances, well known methods, procedures, components, and circuits have not been described in detail as not to unnecessarily obscure aspects of the invention.

Unless specifically stated otherwise as apparent from the following discussions, it is appreciated that throughout the present detailed description, discussions utilizing terms such as “determining”, “preventing”, “performing”, “issuing”, “suspending” or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present technology for enabling access to more than one encrypted data segment of a segmentable data stream is also well suited to the use of other computer systems such as, for example, optical and mechanical computers. Additionally, it should be understood that in embodiments of the present technology for enabling access to more than one encrypted data segment of a segmentable data stream, one or more of the steps can be performed manually.

### EXAMPLE COMPUTER SYSTEM ENVIRONMENT

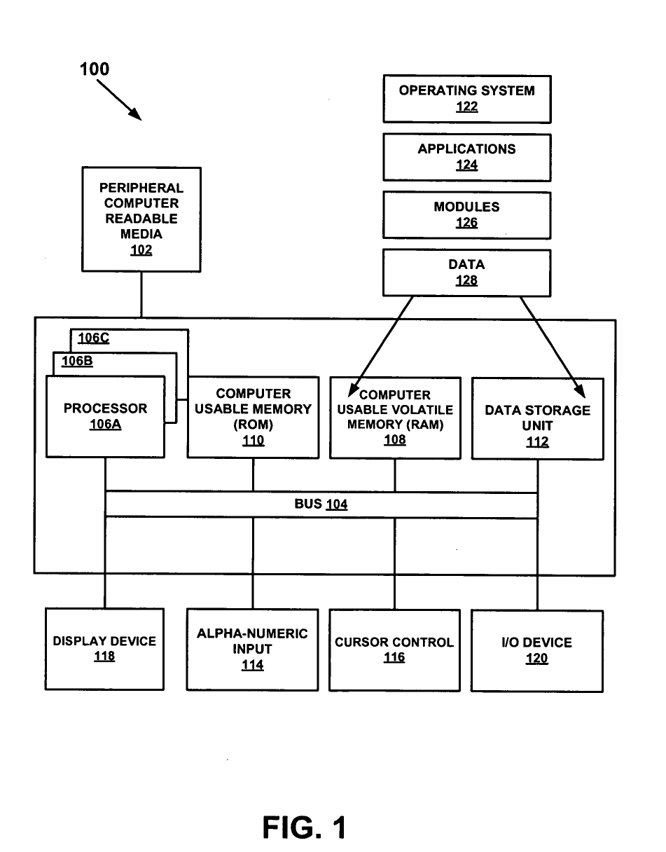

With reference now to FIG. 1, portions of the secure random access to multimedia technology are composed of computer-readable and computer-executable instructions that reside, for example, in computer-usable media of a computer system. That is, FIG. 1 illustrates one example of a type of computer that can be used to implement embodiments, which are discussed below, of the present secure random access to multimedia technology. FIG. 1 illustrates an exemplary computer system 100 used in accordance with one embodiment of the present technology for secure random access to multimedia. It is appreciated that system 100 of FIG. 1 is exemplary only and that the present technology for secure random access to multimedia can operate on or within a number of different computer systems including general purpose networked computer systems, embedded computer systems, routers, switches, server devices, client devices, various intermediate devices/nodes, stand alone computer systems, and the like. As shown in FIG. 1, computer system 100 of FIG. 1 is well adapted to having peripheral computer readable media 102 such as, for example, a floppy disk, a compact disc, and the like coupled thereto.

System 100 of FIG. 1 includes an address/data bus 104 for communicating information, and a processor 106A coupled to bus 104 for processing information and instructions. As depicted in FIG. 1, system 100 is also well suited to a multi-processor environment in which a plurality of processors 106A, 106B, and 106C are present. Conversely, system 100 is also well suited to having a single processor such as, for example, processor 106A. Processors 106A, 106B, and 106C may be any of various types of microprocessors. System 100 also includes data storage features such as a computer usable volatile memory 108, e.g. random access memory (RAM), coupled to bus 104 for storing information and instructions for processors 106A, 106B, and 106C. System 100 also includes computer usable non-volatile memory 110, e.g. read only memory (ROM), coupled to bus 104 for storing static information and instructions for processors 106A, 106B, and 106C. Also present in system 100 is a data storage unit 112 (e.g., a magnetic or optical disk and disk drive) coupled to bus 104 for storing information and instructions. System 100 also includes an optional alphanumeric input device 114 including alphanumeric and function keys coupled to bus 104 for communicating information and command selections to processor 106A or processors 106A, 106B, and 106C. System 100 also includes an optional cursor control device 116 coupled to bus 104 for communicating user input information and command selections to processor 106A or processors 106A, 106B, and 106C. System 100 of the present embodiment also includes an optional display device 118 coupled to bus 104 for displaying information.

Referring still to FIG. 1, optional display device 118 may be a liquid crystal device, cathode ray tube, plasma display device or other display device suitable for creating graphic images and alphanumeric characters recognizable to a user. Optional cursor control device 116 allows the computer user to dynamically signal the movement of a visible symbol (cursor) on a display screen of display device 118. Many implementations of cursor control device 116 are known in the art including a trackball, mouse, touch pad, joystick or special keys on alpha-numeric input device 114 capable of signaling movement of a given direction or manner of displacement. Alternatively, it will be appreciated that a cursor can be directed and/or activated via input from alpha-numeric input device 114 using special keys and key sequence commands. System 100 is also well suited to having a cursor directed by other means such as, for example, voice commands. System 100 also includes an I/O device 120 for coupling system 100 with external entities. For example, in one embodiment, I/O device 120 is a modem for enabling wired or wireless communications between system 100 and an external network such as, but not limited to, the Internet. A more detailed discussion of the present secure random access to multimedia technology is found below.

Referring still to FIG. 1, various other components are depicted for system 100. Specifically, when present, an operating system 122, applications 124, modules 126, and data 128 are shown as typically residing in one or some combination of computer usable volatile memory 108, e.g. random access memory (RAM), and data storage unit 112. In one embodiment of the present secure random access to multimedia technology, the secure random access to multimedia is, for example, a common memory location within RAM 108.

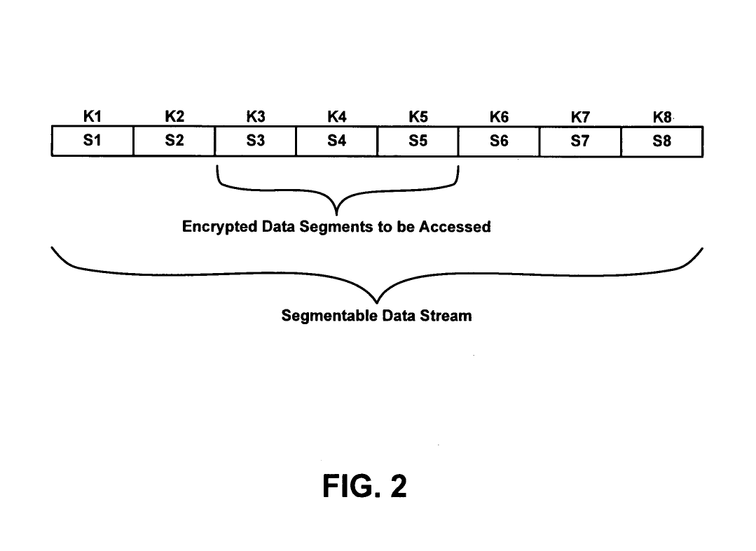

Referring now to FIG. 2, for the purpose of the present discussion, multimedia data can be thought of as including a segmentable data stream in accordance with one embodiment. The segmentable data stream is in turn further includes a plurality of encryptable data segments e.g., S1 through S8. An example of a segmentable data stream is a video stream of a movie, where each segment represents a certain portion of the movie. Another example of a segmentable data stream is an audio stream of a record album where each segment represents, for example, a track within the record album.

Referring still to FIG. 2 each data segment of the segmentable data stream may be encrypted and have a corresponding encryption key. Encryption keys 1 through 8, e.g., K1 through K8, correspond to data segments of the segmentable data stream, e.g., S1 through S8 respectively. The encrypted data segments to be accessed may be any portion of the segmentable data stream (e.g., data segments S3, S4 and S5) encrypted with their corresponding encryption keys (e.g., encryption keys K3, K4 and K5) respectively.

The encrypted data segments to be accessed, e.g., S3, S4 and S5, may be related. For example, the encrypted data segments to be accessed may be related by being the middle act of a play or by being a particular action sequence in a movie or by being a single track or portion of a single track of a song in an album to name a few. In one embodiment, a relationship between encrypted data segments to be accessed can simply be determined according to encrypted data segments' temporal proximity.

The following discussion will begin with a description of the physical structure for providing a secure random access to multimedia data. This discussion will then be followed with an operation description.

### Secure Random Access System

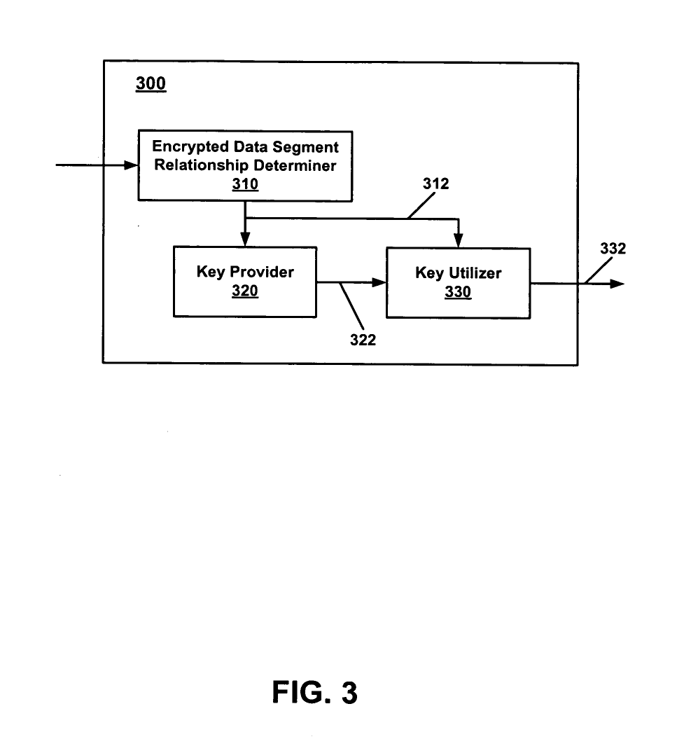

With reference now to FIG. 3, a diagram of the physical structure of a system 300 for providing a secure random access to multimedia data is shown in accordance with one embodiment. In general, system 300 determines a relationship between encrypted data segments which are to be accessed and assigns a common key which can be utilized to access the related encrypted data segments.

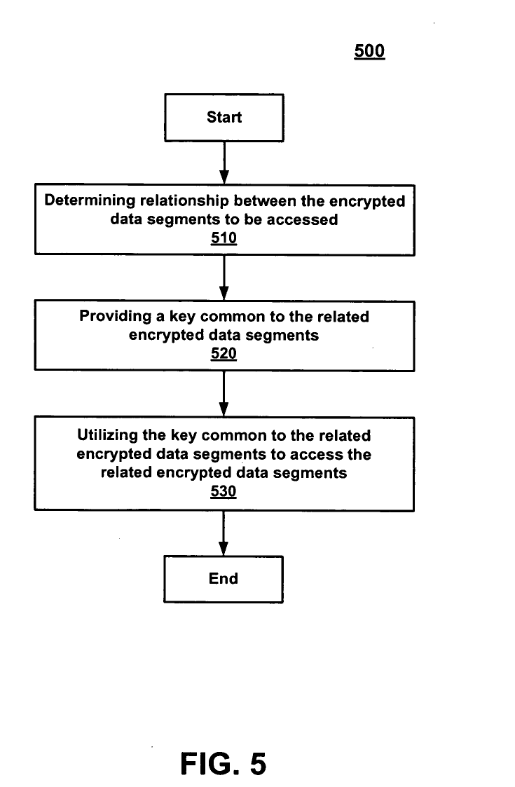

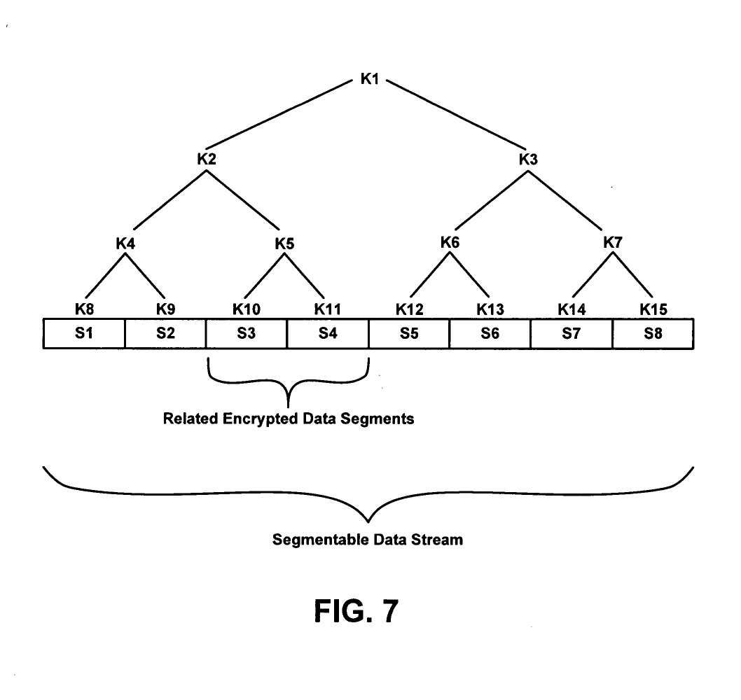

In one embodiment, system 300 includes three components. The first component is an encrypted data segment relationship determiner 310, hereafter referred to as “determiner 310,” which is coupled with a key provider 320 and with a key utilizer 330. Furthermore, key provider 320 is separately coupled with key utilizer 330. Functionality of each of the mentioned components will be described in detail in conjunction with a flow diagram shown in FIG. 5 and accompanying examples shown in FIGS. 7, 8 and 9 below.

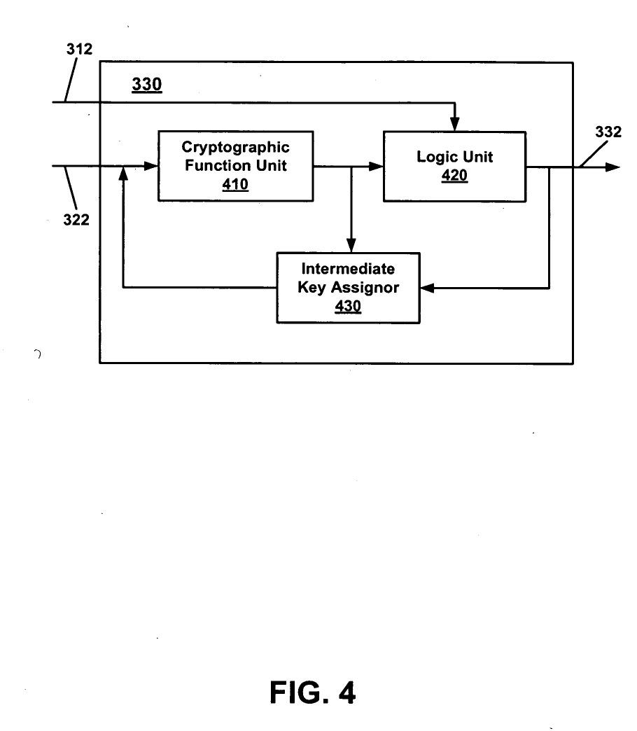

Referring now to FIG. 4, a key utilizer 330 is shown in accordance with one embodiment. Key utilizer 330 includes a cryptographic function unit 410 which is coupled with a logic unit 420 and an intermediate key assignor 430. Functionality of each of the mentioned components will be described in greater detail in conjunction with FIGS. 5, 6, 7, 8 and 9.

### In Operation

Referring not to FIG. 5, a flowchart of a method 500 for securing random access to a plurality of encrypted data segments of a data stream is shown in accordance with one embodiment.

With reference now to 510 of FIG. 5, the relationship between the encrypted data segments to be accessed is determined. As discussed above, the relationship between the encrypted data segments to be accessed may take various forms. For example, the related data segments may be a portion of a play or other performance, a particular sequence of a movie, a single track of an album, a portion of a song, etc. Alternatively, a relationship may simply be determined according to a temporal proximity of the data segments to be accessed.

In one embodiment, determiner 310 receives the encrypted data segments which are to be accessed, e.g., 302, and determines the relationship between at least two or more of the encrypted data segments. The encrypted data segments 302 are a subset of a segmentable data stream which typically has more than one encrypted data segment. If possible, determiner 310 determines the relationship between all segments of the encrypted data segments to be accessed 302. In another embodiment, determiner 310 may determine a relationship between only some, or none, of the segments of encrypted data segments. In one embodiment, determiner 310 outputs the related encrypted data segments 312 to the key provider 320 and the key utilizer 330.

Reference will now be made to FIG. 7 which is an example of determining the relationship between the encrypted data segments in accordance with one embodiment. In FIG. 7, the segmentable data stream includes eight encryptable data segments, e.g., S1 through S8. Each data segment of the segmentable data stream has a corresponding encryption key, e.g., K8 through K15, correspond to data segments S1 through S8 respectively. In the present example, the encrypted data segments to be accessed are data segments S3 and S4 which are encrypted with their respective encryption keys, e.g., K10 and K11.

With reference now to 510 of FIG. 5, determiner 310 is first used to determine whether a relationship between the related encrypted data segments exists. In the example of FIG. 7, it is determined that data segments S3 and S4 are related by a common key, e.g., K5, which is assigned to the related encrypted data segments. For example by applying a hash function to key K5 one may derive the respective encryption keys, e.g., K10 and K11, for data segments S3 and S4. Thus, data segments S3 and S4 are related by a common key, K5.

Referring now to 520 of FIG. 5, a key common to the related encrypted data segments is provided. In one embodiment, the key provider 320 is used to assign a common key to the encrypted data segments 312 which were determined to be related in step 510 above. The assigned key is dependent upon the relationship between the related encrypted data segments as previously established by determiner 310. The assigned key can then be used to access the related encrypted data segments 302. Typically, the assigned key is not required to provide access to the entire segmentable data stream.

If all of the encrypted data segments 302 are related, the assigned key can be used to access all of the encrypted data segments. On the other hand if all of the encrypted data segments 302 are not related, the assigned key can only be used to access the related encrypted data segments.

After providing a common key to the related encrypted data segments, the key provider 320 outputs the assigned keys 322 common to the related encrypted data segments to the key utilizer 330. A second input to the key utilizer 330 is the related encrypted data segments 312 received from determiner 310.

Referring again to FIG. 7, key provider 320 assigns key K5 to data segments S3 and S4. Then, common key K5, as well as encrypted data segments S3 and S4, are sent to key utilizer 330 of FIG. 3. As discussed before, the key utilizer 330 utilizes the assigned key 322, e.g., K5, in order to facilitate accessing the related encrypted data segments, e.g., S3 and S4, by applying secure hash functions to key K5. In other words, common key K5 is used to derive the corresponding encryption keys, e.g., K10 and K11, respectively for data segments S3 and S4. Encryption keys K10 and K11 can then be used to decrypt the related encrypted data segments, e.g., S3 and S4 respectively.

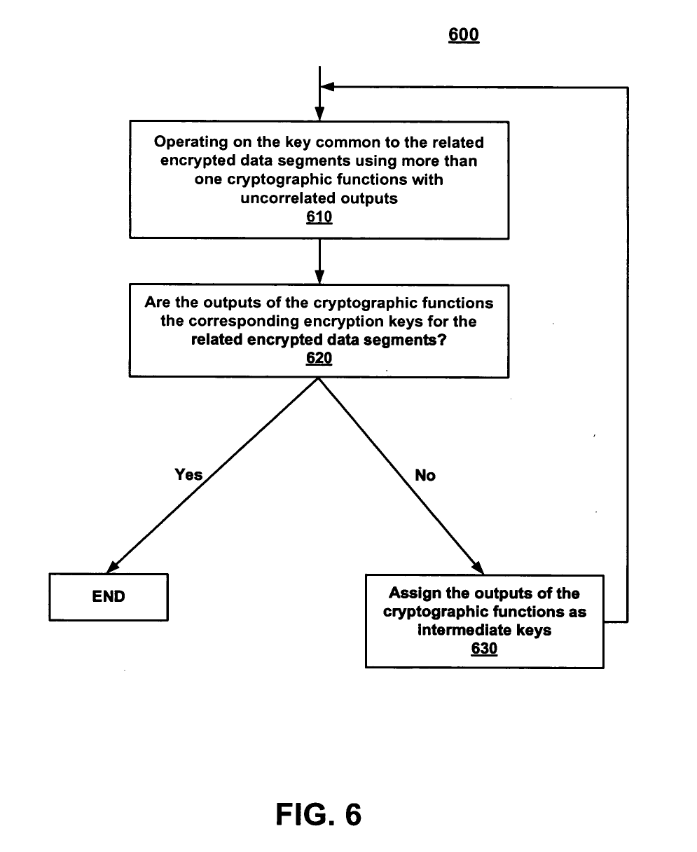

At key utilizer 530, the key common to the related encrypted data segments is utilized to access the related encrypted data segments. In one embodiment the key utilizer 330 utilizes the assigned key 322 in order to derive the corresponding encryption keys for each of the related encrypted data segments 312, e.g., by using secure hash functions. In so doing, the corresponding encryption keys, e.g., 332, for each of the individual related encrypted data segments 312 is generated. The key utilizer 330 then outputs the corresponding encryption keys 332 for the related encrypted data segments 312. The corresponding encryption keys 332 can then be used to decrypt the related encrypted data segments 312. The decrypted data segments of the related encrypted data segments 312 are the content of the related portion of the segmentable multimedia data stream to be accessed. Operation of an exemplary key utilizer is discussed below with reference to FIG. 6.

Therefore, unlike conventional approaches, embodiments described herein enable one to selectively access encrypted segments of a segmentable data stream without requiring a unique encryption key for each data segment. Furthermore, embodiments described herein facilitate accessing a portion of a segmentable data stream without granting access to the entire data stream.

With reference now to FIG. 6, a flowchart of a method 600 describing the operation of key utilizer 330 is shown in accordance with one embodiment.

Referring now to 610 of FIG. 6, the common key for the related encrypted data segments is operated on using more than one cryptographic function, e.g., two cryptographic functions, with uncorrelated outputs. Using cryptographic functions, such as hash functions, with uncorrelated outputs typically makes it infeasible to find their inverse, hence reducing the likelihood of unauthorized access to multimedia data. Two exemplary hash functions may include:

H₁(x)=(x−1)̂7 mod 37, and

H₂(x)=(x+1)̂7 mod 37.

This example assumes that the keys are numbers between 0 and 36 inclusive. Thus, the hash functions would obviously differ if the keys are based on a different set of numbers which is quite possible. Thus, the present hash example is provided merely for purposes of brevity and clarity.

In one embodiment, cryptographic function unit 410 receives the assigned key 322 common to the related encrypted data segments 312. The assigned key 322 is operated on by the cryptographic functions in order to obtain the corresponding encryption keys for each of the related encrypted data segments 312. For example, the cryptographic function unit 410 may use the two hash functions shown above in order to operate on the assigned key 322.

With reference now to 620 of FIG. 6, the uncorrelated outputs of the cryptographic functions are checked in order to determine whether those outputs are the corresponding encryption keys for the related encrypted data segments. In one embodiment, determining whether the outputs of the cryptographic functions are the corresponding encryption keys to the related encrypted data segments is achieved by using a logic unit 420. The logic unit 420 receives the outputs of the cryptographic function unit 410 as its input. Furthermore, the logic unit 420 receives the related encrypted data segments 312.

Referring now to 630 of FIG. 6, if it is determined that the outputs of the cryptographic function unit are not the corresponding encryption keys, e.g., 322 of FIG. 3, the outputs of the cryptographic functions are assigned as intermediate keys. In one embodiment, assigning the outputs of the cryptographic functions as intermediate keys is accomplished by using the intermediate key assignor 430. The intermediate key assignor 430 receives the outputs of the cryptographic function unit 410 as its input. As such, the intermediate key assignor 430 assigns the outputs of the cryptographic function unit 410 as the intermediate keys and then sends the intermediate keys back to cryptographic function unit 410. This process of sending the intermediate keys back to cryptographic function unit 410 is repeated until it is determined that the outputs of cryptographic function unit 410 are the corresponding encryption keys, e.g., 322 of FIG. 3, of the related encrypted data segments 312. Then, when the analysis determines that the outputs of cryptographic function unit 410 are the corresponding encryption keys 322 of the related encrypted data segments 312, method 600 ends.

Referring once again to FIG. 7, encrypted data segments S3 and S4 are received by logic unit 420 while common key K5 is received by cryptographic function unit 410. The common key K5 is operated on by cryptographic function unit 410 using the two hash functions H₁(x) and H₂(x). H₁ (K5). In the present example, H₁(x) corresponds to K10 and H₂ (K5) corresponds to K11. For illustration purposes it is assumed that the common key K5=5. Hence, x=5 and it is operated on by the two hash functions with uncorrelated outputs. H₁ (5) and H₂ (5) provide the two uncorrelated outputs {30, 31} respectively. As such, K10=30 and K11=31.

In one embodiment, the uncorrelated outputs H₁ (5) and H₂ (5) are then sent to logic unit 420. Generally, the key values themselves cannot be used to determine if they are appropriate for their segments. The relevant observation is that the *tree structure* determines that K5 will generate keys for segments S3 and S4. Thus, it is the key index, not its value that is used to determine whether they are the corresponding encryption keys for the data segments S3 and S4. If logic unit 420 determines that the outputs of the cryptographic function unit 410 are the corresponding encryption keys for the related data segments 312, encryption keys K10 and K11 are then used to decrypt the data segments S3 and S4. Thus, K10=30 is output as the assigned key 332 for data segment S3, and K11-32 is output as the assigned key 332 for data segment S4.

As shown in FIG. 7, embodiments described herein are advantageous in that fewer decryption keys are sent to a user while still preserving secure access to selected portions of the data stream. Thus, by reducing the number of keys which are decrypted by the user's computer, secure access to selected portions of the data stream is significantly less time consuming.

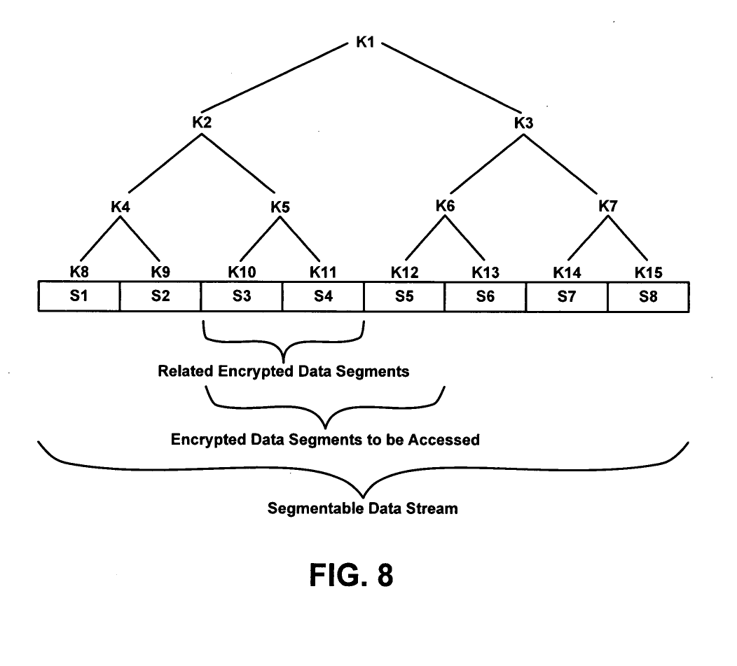

With reference now to FIG. 8, another example for providing a common key is shown in accordance with one embodiment. For example, three data segments, e.g., S3, S4, and S5 are to be accessed. As discussed above, determiner 310 determines whether a relationship exists between the encrypted data segments. In the example, a relationship does exist between data segments S3 and S4 and a common key, e.g., K5 is assigned to them by key provider 320. Thus, the assigned key K5 can be used to access the related encrypted data segments S3 and S4 by deriving their respective corresponding encryption keys as described above with reference to FIG. 7. Thus, key utilizer 320 outputs keys K10 and K11 as the keys corresponding keys 332 for data segments S3 and S4 respectively.

In one embodiment, no relationship is established between data segment S5 and either of data segments S3 or S4. Thus, common key K5 cannot be used to derive a corresponding key, e.g., K12, with which to access data segment S5. As a result, The tree structure determines which key with which index will be used for decrypting which segment.

For example, the source would send the following information to the receiver: (8, [3, 4, 5], [K, K′]). Assuming that sender and receiver have agreed upon a binary tree structure, the value 8 would signal to the receiver that there are 8 segments in the stream, and the sequence [3,4,5] that he will receive keys for decrypting segments 3, 4 and 5. The receiver will than conclude that these segment are covered by node 5 and 12. If the receiver and sender had agreed upon a key order, the receiver could than know that the first key K would correspond to node 5 and the second key K′ to node 12.

Another option would be for the sender to send the info (8,[5, 12],[K,K′]). Again, assuming the sender and receiver having agreed upon the tree structure, this would be enough information for the receiver to know that segments 3, 4 and 5 can be decrypted.

More importantly, there is *nothing special* about key K12. That is, no special flagging is needed.

Therefore, in one embodiment, the sender always sends a triple (N, [nodes],[keys}) where [nodes] and [keys] are sequences of equal length (or something similar in spirit), assuming that sender and receiver have agreed upon a tree structure. The receiver will know that no further processing of k12 is needed.

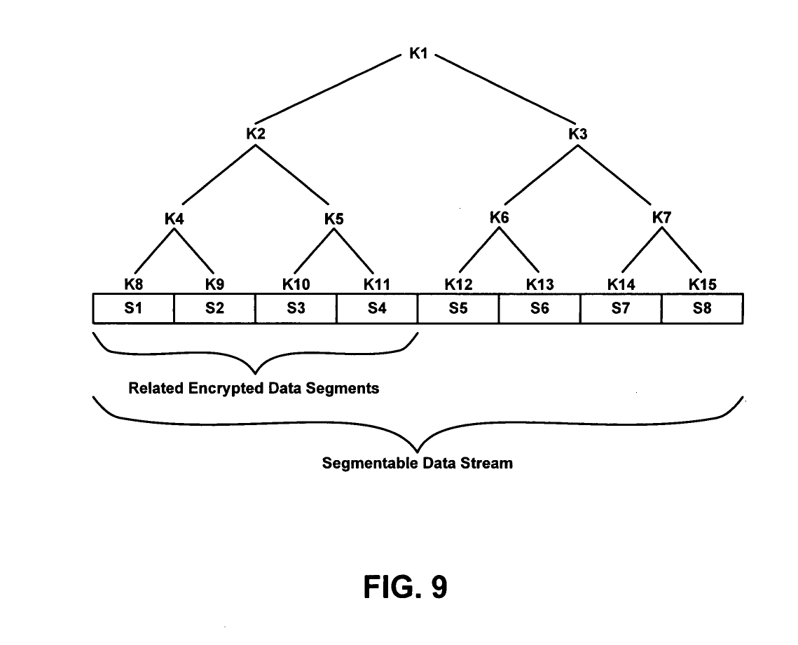

Another example for providing a common key is shown in FIG. 9. In FIG. 9, data segments S1, S2, S3, and S4 are to be accessed. As discussed before determiner 310 determines whether a relationship exists between any of the encrypted data segments being accessed. In the embodiment, determiner 310 ascertains that data segments S1-S4 are related. In one embodiment, as a result of this determination, key provider 320 assigns key K2 to the related encrypted data segments S1-S4.

As discussed above, intermediate keys K4 and K5 can be derived by applying the hashing functions to assigned key K2. As an example, referring once again to FIG. 9, key K2 is operated on by the two hash functions H₁(x) and H₂(x). Applying hashing function H1 (K2) results in key K4 while hashing function H₂ (K2) results in key K5. For illustration purposes it is assumed that K2=5. In the present example, the uncorrelated output of the two hash functions H₁ (5) and H₂ (5) are then {30, 31} respectively. In other words, K4=30 and K5=31.

As discussed above with reference to FIG. 6, logic unit 420 may determine whether keys K4 and K5 correspond to any of the data segments, e.g., S1-S4, to be accessed. In the present example, it is determined that keys K4 and K5 do not correspond to any of the data segments S1-S4. As a result, keys K4 and K5 are returned to cryptographic function unit 410 via intermediate key assignor 430 and the hashing functions are separately applied to keys K4 and K5. In other words, the hashing functions are applied to the new values, e.g., 30 and 31. The use of the same hash functions is for illustration purposes only. It is noted that different hash functions may be utilized on successive intermediate keys as long as hash functions used have uncorrelated outputs.

In the present example, H1 (K4) and H₂ (K4) derive the keys K8 and K9 respectively, while H1 (K5) and H₂ (K5) derives the keys K10 and K11 respectively. These new keys are then analyzed by logic unit 420 to determine if any of them correspond to the data segments S1-S4. In the present example, the keys K8-K11 do correspond to data segments S1-S4 respectively and the keys are output as corresponding keys 332.

Alternatively, determiner 310 may ascertain related data segments with greater granularity and instead determine that data segments S1 and S2 are related and that data segments S3 and S4 are related. As a result, key provider 320 assigns key K4 to data segments S1 and S2, and assigns key K5 to data segments S3 and S4. The hashing functions are then applied to key K4 to derive the corresponding keys K8 and K9. The hashing functions are also applied to key K5 to derive the corresponding keys K10 and K11. In this scenario, it is assumed that the common keys assigned by key provider 320 are K4=30 and K5=31. Using the two hash functions H₁(x) and H₂(x) on the value of K4 results in deriving the corresponding encryption keys, e.g., K8 and K9, for data segments S1 and S2 respectively. Similarly, using the two hash functions H₁(x) and H₂(x) on the value of K5 results in the corresponding encryption keys, e.g., K10 and K11, for data segments S3 and S4 respectively. In other words H (K4), H₂ (K4), H1 (K5) and H₂ (K5) result in the respective values of {8, 6, 3, 19}, which are the corresponding encryption keys for the related encrypted data segments S1-S4. Although this is an unlikely scenario, given that the sender wants to minimize bandwidth, it is provided herein merely for purposes of establishing the ability to require a combination of keys instead of a single key.

Logic unit 420 then determines, abased on the node labels not on the key values, that the cryptographic function outputs {8, 6, 3, 19} are the corresponding encryption keys for the related encrypted data segments, e.g., S1-S4. In other words, {8, 6, 3, 19} are determined to be the corresponding encryption keys (e.g., K8=8, K9=6, K10=3 and K11=19) for data segments S1-S4 and are used to decrypt them as discussed above.

Thus, embodiments described herein provide a method and system for enabling access to more than one encrypted data segment of a segmentable data stream wherein said data stream includes a plurality of said encrypted data segments. Additionally, embodiments described herein also enable one to selectively access encrypted segments of a segmentable data stream without requiring a unique encryption key for each data segment. Furthermore, embodiments described herein facilitate accessing a portion of a segmentable data stream without granting access to the entire data stream

Embodiments are thus described. While particular embodiments have been described, it should be appreciated that the invention should not be construed as limited by such embodiments, but rather construed according to the following claims.

What is claimed is:

1. A method for enabling access to more than one encrypted data segment of a segmentable data stream wherein said data stream is comprised of a plurality of said encrypted data segments, said method comprising:
determining a relationship between at least two of said encrypted data segments, to define related encrypted data segments;
providing a single key which is common to said related encrypted data segments such that said single key can be used to access said related encrypted data segments; and
utilizing said single key to obtain access to said related encrypted data segments wherein said single key is not required to provide access to the entire said segmentable data stream.

2. The method as described in claim 1 wherein a plurality of keys are associated with said segmentable data stream wherein the hierarchy of said plurality of keys can be represented by a tree structure.

3. The method as described in claim 2 wherein said tree structure is a binary tree.

4. The method as described in claim 1 wherein said single key defines a maximum number of encrypted data segments to be accessed.

5. The method as described in claim 1 wherein said utilizing said single key further comprises:
operating on said single key using more than one cryptographic function with uncorrelated outputs to obtain plurality of intermediate keys which can be operated on recursively using more than one said cryptographic function with uncorrelated outputs to obtain access to said related encrypted data segments.

6. The method as described in claim 5 wherein more than one said cryptographic functions are secure hash functions.

7. A computer-useable medium having computer-readable program code stored thereon for causing a computer system to execute a method for enabling access to more than one encrypted data segment of a segmentable data stream wherein said data stream is comprised of a plurality of said encrypted data segments, said computer-useable medium comprising:
determining a relationship between at least two of said encrypted data segments, to define related encrypted data segments;
providing a single key which is common to said related encrypted data segments such that said single key can be used to access said related encrypted data segments; and
utilizing said single key to obtain access to said related encrypted data segments wherein said single key is not required to provide access to the entire said segmentable data stream.

8. The computer-useable medium as described in claim 7 wherein a plurality of keys are associated with said segmentable data stream wherein the hierarchy of said plurality of keys can be represented by a tree structure.

9. The computer-useable medium as described in claim 8 wherein said tree structure is a binary tree.

10. The computer-useable medium as described in claim 7 wherein said single key defines a maximum number of encrypted data segments to be accessed.

11. The computer-useable medium as described in claim 7 wherein said utilizing said single key further comprises:
operating on said single key using more than one cryptographic function with uncorrelated outputs to obtain plurality of intermediate keys which can be operated on recursively using more than one said cryptographic function with uncorrelated outputs to obtain access to said related encrypted data segments.

12. The computer-useable medium as described in claim 11 wherein more than one said cryptographic functions are secure hash functions.

13. A system for enabling access to more than one encrypted data segment of a segmentable data stream wherein said data stream is comprised of a plurality of said encrypted data segments, said system comprising:
an encrypted data segment relationship determiner for determining a relationship between at least two of said encrypted data segments, to define related encrypted data segments;
a single key provider for providing a single key which is common to said related encrypted data segments such that said single key can be used to access said related encrypted data segments; and
a single key utilizer for utilizing said single key to obtain access to said related encrypted data segments wherein said single key is not required to provide access to the entire said segmentable data stream.

14. The system as described in claim 13 wherein a plurality of keys are associated with said segmentable data stream wherein the hierarchy of said plurality of keys can be represented by a tree structure.

15. The system as described in claim 14 wherein said tree structure is a binary tree.

16. The system as described in claim 13 wherein said single key defines a maximum number of encrypted data segments to be accessed.

17. The system as described in claim 13 wherein said utilizing said single key further comprises:
operating on said single key using more than one cryptographic function with uncorrelated outputs to obtain plurality of intermediate keys which can be operated on recursively using more than one said cryptographic function with uncorrelated outputs to obtain access to said related encrypted data segments.

18. The system as described in claim 17 wherein more than one said cryptographic functions are secure hash functions.
